(19) United States
(12) Patent Application Publication
(10) Pub. No.: US 2008/0181758 A1
(43) Pub. Date: Jul. 31, 2008

(54) Microfeature workpiece transfer devices with rotational orientation sensors, and associated systems and methods

(76) Inventors: Daniel J. Woodruff, Kalispell, MT (US); David P. Mattson, Kalispell, MT (US)

Correspondence Address: PERKINS COIE LLP/SEMITOOL, PO BOX 1208, SEATTLE, WA, 98111-1208, US

(21) Appl. No.: 11/699,762

(22) Filed: Jan. 29, 2007

(51) Int. Cl. B25J 18/00

(52) U.S. Cl. 414/744.5; 901/15

(57) ABSTRACT

Microfeature workpiece transfer devices with rotational orientation sensors, and associated systems and methods are disclosed. A transfer device in accordance with one embodiment includes a base unit movable along a guidepath, and a carrier movable relative to the base unit. The device further includes a position sensor located to identify a rotational orientation of the workpiece while the workpiece is carried by the carrier (e.g., by one or more edge grippers or other end-effector devices). In particular embodiments, the rotational orientation of the workpiece is corrected by appropriately moving articulatable links of the transfer device, and/or by rotating a support that carries the workpiece for processing at a process chamber.

### TECHNICAL FIELD

The present invention is related to microfeature workpiece transfer devices (e.g., robots) with rotational orientation sensors, and associated systems and methods. Systems and methods in accordance with the invention are suitable for rotationally orienting workpieces prior to undertaking a process that is sensitive to rotational orientation.

### BACKGROUND

Microelectronic devices are fabricated on and/or in microelectronic workpieces (e.g., wafers) using several different processing apparatuses or tools. Many such processing tools have a single processing station that performs one or more procedures on the workpieces. Other processing tools have a plurality of processing stations that perform a series of different procedures on individual workpieces or batches of workpieces. The workpieces are often handled by automatic handling equipment (e.g., robots or transfer devices) because microelectronic fabrication requires very precise positioning of the workpieces and/or due to conditions that are not suitable for human access (e.g., vacuum environments, high temperature environments, chemical environments, clean environments, etc.).

An increasingly important category of processing tool is a plating tool that plates metal and other materials onto workpieces. Existing plating tools use automatic handling equipment to handle the workpieces because the position, movement and cleanliness of the workpieces are important parameters for accurately plating materials onto the workpieces. The plating tools can be used to plate metals and other materials (e.g., ceramics or polymers) in the formation of contacts, interconnects and other components of microelectronic devices. For example, copper plating tools are used to form copper contacts and interconnects on semiconductor wafers, field emission displays, read/write heads and other types of microelectronic workpieces. A typical copper plating process involves depositing a copper seed layer onto the surface of the workpiece using chemical vapor deposition (CVD), physical vapor deposition (PVD), electroless plating processes, or other suitable methods. After forming the seed layer, copper is plated onto the workpiece by applying an appropriate electrical field between the seed layer and an anode in the presence of an electrochemical plating solution. The workpiece is then cleaned, etched and/or annealed in subsequent procedures before transferring the workpiece to another tool or apparatus.

Single-wafer plating tools generally have a load/unload station, a number of plating chambers, a number of cleaning chambers, and a transfer mechanism for moving the workpieces between the various chambers and the load/unload station. The transfer mechanism can be a rotary system having one or more robots that rotate about a fixed location in the plating tool. Other existing transfer mechanisms include linear systems that have an elongated track and a plurality of individual robots that can move independently along the track. Each of the robots on the linear track can also include independently operable end-effectors. Many rotary and linear transfer mechanisms have a plurality of individual robots that can each independently access most, if not all, of the processing stations within an individual tool to increase the flexibility and throughput of the plating tool.

The foregoing robots typically use end-effectors to carry workpieces from one processing station to another. The nature and design of the end-effectors will depend, in part, on the nature of the workpiece being handled. For example, when the backside of the workpiece may directly contact the end-effector without adverse consequences, a vacuum-based end-effector may be used. Such vacuum-based end-effectors typically have a plurality of vacuum outlets that draw the backside of the workpiece against a paddle or other type of end-effector. In other circumstances, however, the workpieces have components or materials on both the backside and the device side that cannot be contacted by the end-effector. For example, workpieces that have wafer-level packaging have components on both the device side and the backside. Such workpieces typically must be handled by edge-grip end-effectors, which contact the edge of the workpiece and only a small perimeter portion of the device side and/or the backside of the workpiece. Edge-grip end-effectors accordingly avoid introducing particle contamination on the backside of the workpiece.

The workpieces carried by the foregoing robots typically have a notch or flat edge that identifies the crystal plane orientation of an individual workpiece. Many processes performed on the workpiece are performed independently of the crystal plane orientation. However, some processes are orientation-dependent, including at least some processes in which magnetic materials are applied to or removed from the workpiece. In such cases, the workpiece must have the proper rotational orientation in the processing chamber when the orientation-sensitive process is performed. A pre-aligner is typically used to rotationally orient the workpiece. The pre-aligner includes a sensor that detects the location of the notch, and a chuck or other device that rotates the workpiece to the proper rotational orientation.

In many cases, the pre-aligner is located at a dedicated pre-aligner station in the processing tool. Workpieces are transferred directly from the load/unload station to the pre-aligner station before undergoing any other processes at the tool. One drawback with this approach is that the workpiece may become misaligned as a result of being gripped and released multiple times at multiple process stations prior to reaching the station where the rotational orientation of the workpiece is particularly significant. For example, the workpiece may undergo a pre-wet process, a plating process, and a spin/rinse/dry sequence prior to undergoing deposition of magnetically-sensitive materials.

One approach to this problem is to transport the workpiece back to the pre-aligner station immediately prior to undergoing the orientation-sensitive process. However, this process takes time. Furthermore, if the workpiece is wet as a result of the immediately foregoing process, it typically must be dried before being handled by the pre-aligner, which takes additional time, and further reduces the rate at which workpieces are processed.

Another approach to addressing the foregoing problem is to install a pre-aligner device on the robot so that the workpiece can be rotationally oriented or re-oriented without first having to be transported to a separate pre-aligner station. However, robot-borne pre-aligners typically include a vacuum chuck, and operation of the vacuum chuck typically requires that the workpiece be dry prior to being carried by the chuck. Accordingly, wet wafers must undergo at least a drying process prior to being re-oriented at the robot, and this again takes time and reduces the throughput of the tool.

In light of the foregoing, it would be desirable to provide an apparatus and method for quickly and efficiently adjusting or correcting the rotational orientation of a workpiece prior to conducting a process on the workpiece that is sensitive to the rotational orientation. It would also be desirable to provide such rotational orientation without the need for transferring the workpiece to a dedicated pre-aligner station, or conducting a specific process on the workpiece that is required only for purposes of changing its rotational orientation (e.g., drying the workpiece).

### SUMMARY

The present invention provides transfer devices and associated systems and methods that reduce the amount of time required to orient or re-orient a workpiece prior to performing a process on the workpiece. As a result, the workpieces are processed more quickly, increasing the overall throughput of the tool in which the transfer device is installed, and therefore increasing the efficiency with which semiconductor chips and/or other devices are manufactured.

Transfer devices in accordance with the invention include a base unit that is moveable along a guide path, and a carrier that is moveable relative to the base unit. The carrier includes an end-effector that engages the workpiece and moves it toward and away from the base. The transfer device further includes a position sensor located to identify a rotational orientation of the microfeature workpiece while the microfeature workpiece is carried by the end-effector. Accordingly, the transfer device need not include a separate support that holds the workpiece while identifying the rotational orientation of the workpieces. Instead, the same end-effector can carry the workpiece while it is transferred to and from processing stations, and while the rotational orientation of the workpiece is identified. In a particular arrangement, the end-effector has edge grippers positioned to engage an edge of a microfeature workpiece. Accordingly, the rotational orientation of the workpiece can be determined at the transfer device, without requiring the workpiece to be supported centrally, e.g., with a vacuum chuck. This particular arrangement also eliminates the need to dry the workpiece prior to supporting it during detection of its rotational orientation.

The position sensor is operatively coupled to a controller (e.g., via a wireless or other communication link) to provide signals corresponding to the rotational orientation of the workpiece. The controller can compare the detected rotational orientation of the workpiece with a target value, determine a rotational orientation correction value, and direct a signal corresponding to the correction value.

The rotational orientation of the workpiece is updated or corrected in one or more ways. For example, the transfer device can move the workpiece to a support positioned proximate to a processing chamber, and the support can rotate the workpiece to its correct orientation and then carry the workpiece at the processing chamber during the ensuing process. In another arrangement, the transfer device includes multiple, articulatable links. The links are positioned in such a way as to properly orient the workpiece as it is handed off to the support so that once at the support, the workpiece has the proper orientation for processing. In both cases, the workpiece is rotationally oriented without the need for transferring the workpiece to a dedicated pre-aligner station, and without the need for a separate support that holds the workpiece while its rotational orientation is identified.

### BRIEF DESCRIPTION OF THE DRAWINGS

FIG. 1 is a top isometric view of a tool having a transfer device arranged in accordance with an embodiment of the invention.

FIG. 2 is an enlarged isometric view of the transfer device shown in FIG. 1, configured in accordance with an embodiment of the invention.

FIG. 3 is a flow diagram illustrating a process for detecting and correcting or updating the rotational orientation of a workpiece in accordance with an embodiment of the invention.

FIG. 4 is an isometric illustration of a transfer device moving a microfeature workpiece to a support for rotational re-orientation in accordance with an embodiment of the invention.

FIG. 5 is an isometric illustration of a transfer device positioned to correct or update the rotational orientation of a workpiece by virtue of its location when the workpiece is transferred to a support, in accordance with another embodiment of the invention.

### DETAILED DESCRIPTION

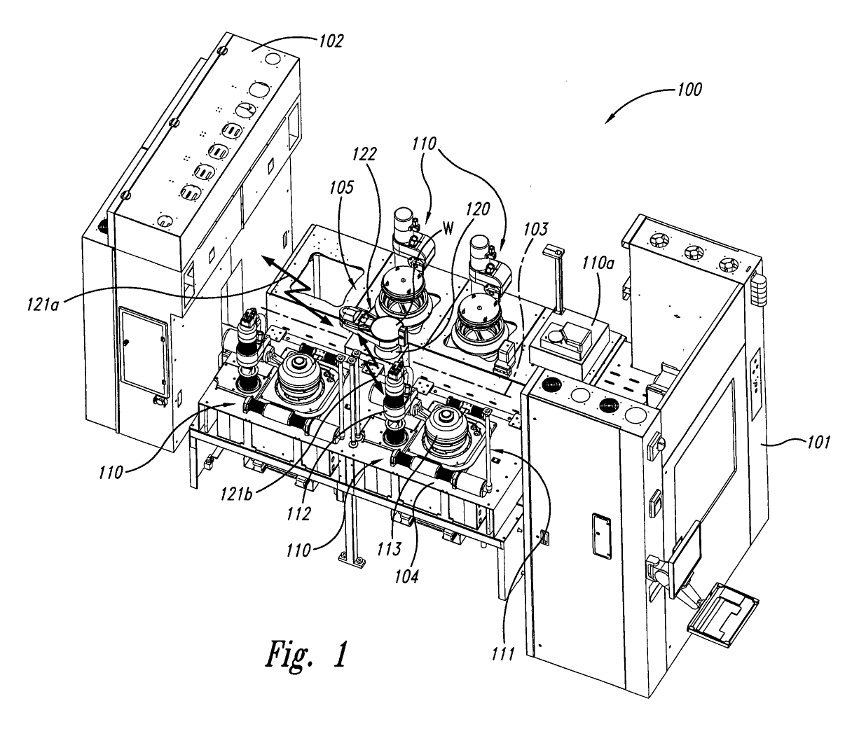

The following description discloses the details and features of several embodiments of transfer devices for handling microfeature workpieces, and methods for making and using such devices. The terms “microfeature workpiece” and “workpiece” refer to substrates on and/or in which micro-devices are formed. Typical micro-devices include microelectronic circuits or components, thin-film recording heads, data storage elements, micro-fluidic devices, and other products. Micro-machines or micromechanical devices are included within this definition because they are manufactured in much the same manner as integrated circuits. The substrates can be semiconductive pieces (e.g., silicon wafers or gallium arsenide wafers), non-conductive pieces (e.g., various substrates), or conductive pieces (e.g., doped wafers). It will be appreciated that several of the details set forth below are provided to describe the following embodiments in a manner sufficient to enable a person skilled in the art to make and use the disclosed embodiments. Several of the details and advantages described below, however, may not be necessary to practice certain embodiments of the invention. Additionally, the invention may also include other embodiments that are also within the scope of the claims, but are not described in detail with reference to FIGS. 1-5.

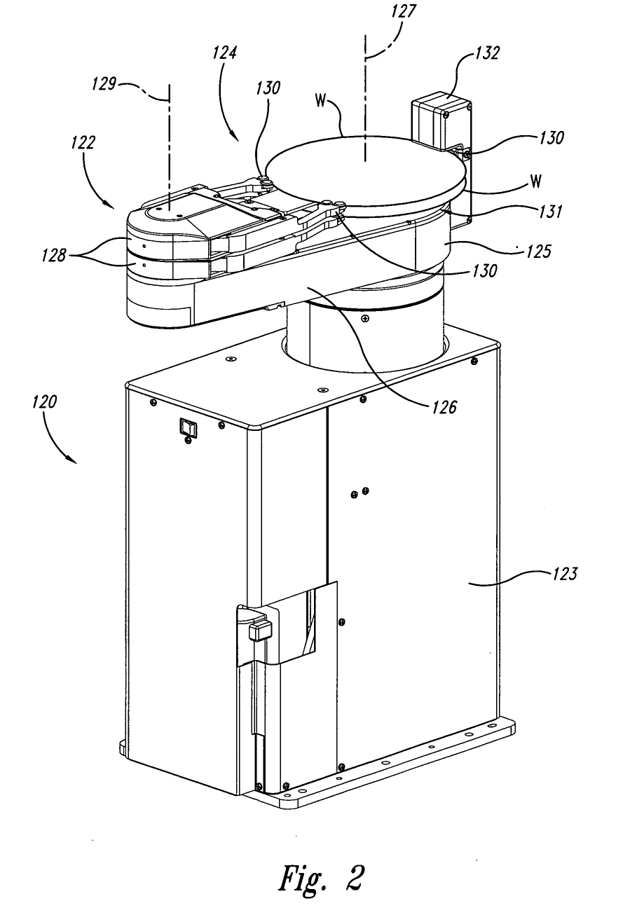

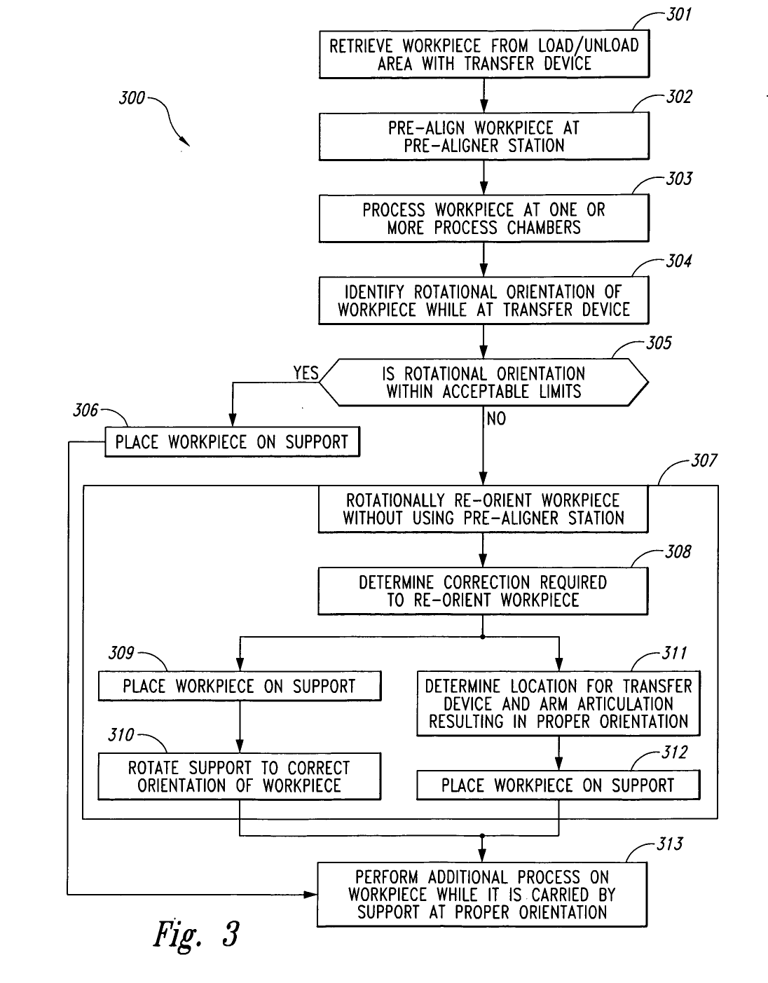

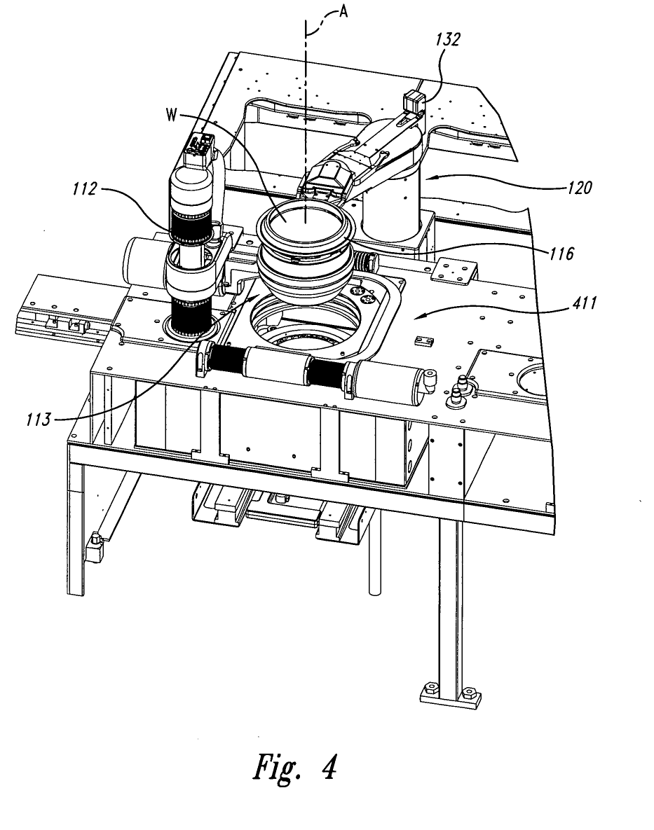

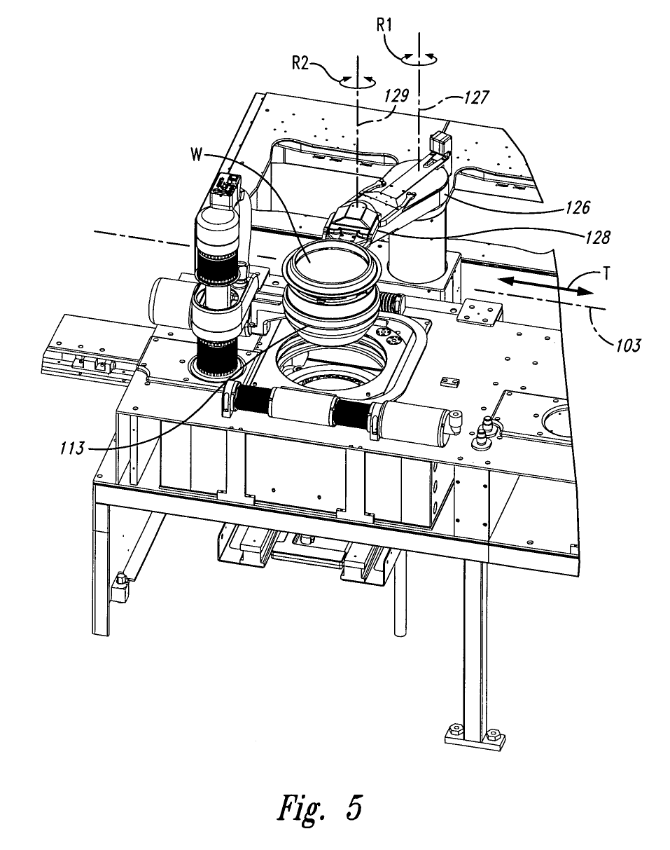

The operation and features of transfer devices for handling microfeature workpieces are best understood in light of the environment and equipment in which they can be used. Accordingly, a representative processing tool in which the transfer devices can be used is described with reference to FIG. 1. Additional details of a representative transfer device are described with reference to FIG. 2, and a flow diagram outlining representative methods for using the transfer device is described with reference to FIG. 3. The operations of transfer devices in accordance with several embodiments are then described with reference to FIGS. 4 and 5.

FIG. 1 is a partially schematic, isometric illustration of a tool 100 that performs one or more wet chemical or other processes on microfeature workpieces W. The tool 100 includes a housing or cabinet (removed for purposes of illustration) that encloses a deck 104. The deck 104 supports a plurality of processing stations 110, and a transport system 105. The stations 110 can include rinse/dry chambers, cleaning capsules, etching capsules, electrochemical deposition chambers, annealing chambers, or other types of processing chambers. Each processing station 110 includes a vessel, reactor, or chamber 111 and a workpiece support 112 (for example, a lift-rotate unit) for supporting individual microfeature workpieces W during processing at the chamber 111. The transport system 105 moves the workpieces W to and from the chambers 111. Accordingly, the transport system 105 includes a transfer device or robot 120 that moves along a linear guidepath 103 to transport individual workpieces W within the tool 100. The tool 100 further includes a workpiece load/unload unit 101 having a plurality of containers for holding the workpieces W as they enter and exit the tool 100.

In operation, the transfer device 120 has a first carrier 122 with which it carries the workpieces W from the load/unload unit 101 to the processing stations 110 according to a predetermined workflow schedule within the tool 100. Typically, each workpiece W is initially aligned at a pre-aligner station 110a before it is moved sequentially to the other processing chambers 110. At each processing station 110, the transfer device 120 transfers the workpiece W from the first carrier 122 to a second carrier 1 13 located at the support 112. The second carrier 113 then carries workpiece W for processing at the corresponding process chamber 111. A controller 102 receives inputs from an operator and, based on the inputs, automatically directs the operation of the transfer device 120, the processing stations 110, and the load/unload unit 101. The transfer device 120 can also communicate with the controller 102 (e.g., via a first wired or wireless communication link 121a), and/or directly with the support 112 (e.g., via a second wired or wireless communication link 121b). In this manner, information corresponding to the orientation of the workpieces W is communicated from the transfer device 120 to portions of the tool 100 that control or implement the reorientation of the workpieces W.

FIG. 2 illustrates a representative transfer device 120 in accordance with an embodiment of the invention. The transfer device 120 has a base 123 that moves along the guidepath 103 (FIG. 1), and supports the first carrier 122. The first carrier 122 includes one or more articulatable links 124. In the illustrated embodiment, the links 124 include an arm 126 supported on a column 125 for rotation about an arm rotation axis 127, and one or more end-effectors 128 (two are shown in FIG. 2) that are rotatable relative to the arm 126 about an end-effector rotation axis 129. The end-effector rotation axis 129 is offset from the arm rotation axis 127, and eccentric relative to the center of the workpiece W. In the illustrated embodiment, each end-effector 128 is configured to carry a single workpiece W. Each end-effector 128 includes multiple grippers 130 that grip the edges of a workpiece W at a corresponding gripping region 131. In the arrangement shown in FIG. 2, each end-effector 128 includes three grippers 130, two of which are visible in FIG. 2 and one of which is hidden by the position sensor 132. Accordingly, the workpieces W remain gripped by their edges while being carried by the transfer device 120. The workpieces W can be moved to a wide variety of positions and orientations via rotation of the arm 126 and/or the end-effectors 128. In a particular arrangement, one of the three grippers 130 is fixed (e.g., the one hidden by the position sensor 132) and the other two (e.g., those visible in FIG. 2) move toward and away from the fixed gripper 130. Further details of such an arrangement are disclosed in pending U.S. application Ser. No. 11/480,313, filed on Jun. 29, 2006 and incorporated herein by reference. The end-effectors 128 can have other arrangements in other embodiments, as will be described in further detail later.

The illustrated transfer device 120 includes the position sensor 132, located to identify a rotational orientation of each of the workpieces W. In a particular embodiment, the position sensor 132 is carried by the arm 126, but the position sensor can also be carried by other parts of the transfer device 120, or other parts of the tool 100 (e.g., the deck 104 shown in FIG. 2). The position sensor 132 includes a slot into which the workpiece W is inserted via rotation of the end-effector 128 about the end-effector rotation axis 129. With the workpiece W in the slot, a detector (e.g., an IR detector, laser-based detector, or other detector) housed in the sensor 132 is used to identify a rotational orientation of the workpiece W by detecting a particular feature of the workpiece W. In a particular embodiment, the detected feature includes the flat or notch in the edge of the wafer, and in other embodiments, the feature can have other characteristics. Suitable sensors 132 include an LX2-V series micrometer, available from Keyence Corporation of Osaka, Japan.

FIG. 3 is a flow chart outlining a process 300 for determining the rotational orientation of a microfeature workpiece (e.g., via the position sensor 132 shown in FIG. 2) and, if necessary, updating or correcting the rotational orientation. Process portion 301 includes retrieving a workpiece from an load/unload area with a transfer device, for example, retrieving a workpiece from the load/unload unit 101 with the transfer device 120 shown in FIG. 1. In process portion 302, the workpiece is pre-aligned at a pre-aligner station. The pre-aligner station can carry the workpiece by its edges or centrally via a vacuum chuck or vacuum paddle. In process portion 303, the workpiece is transferred from the pre-aligner station and processed at one or more process chambers. As described above, the processes conducted at the process chambers may include a pre-wet process, a plating process, a spin/rinse/dry sequence, and/or others.

The workpiece may be repeatedly gripped and released as it is moved back and forth between process chambers and the transfer device. As a result, the rotational orientation of the workpiece initially established in process 302 may change. Accordingly, process portion 304 includes identifying a rotational orientation of the workpiece while it is carried by the transfer device, for example, while the workpiece is on its way to a target process chamber at which an orientation-sensitive process is to be performed. In process portion 305, it is determined whether the rotational orientation is within acceptable limits. If so, the workpiece is placed on a workpiece support (process portion 306) and an additional process (e.g., an orientation-sensitive process) is performed on the workpiece while it is carried by the support at its proper rotational orientation (process portion 313). Accordingly, the workpiece is not rotated during some or all of this process. The orientation-sensitive process includes depositing magnetic materials in a representative process flow, but can include other processes in other cases.

If, in process portion 305, it is determined that the rotational orientation of the workpiece is not within acceptable limits, then the method proceeds to process portion 307, which includes rotationally re-orienting the workpiece without using a pre-aligner station. In process portion 308, the correction required to re-orient the workpiece is established, for example, by comparing the sensed or measured orientation with a target orientation. This comparison can be performed by any suitable computer, controller or other device, e.g., by the controller 102 shown in FIG. 1, or by a device carried on-board the transfer device. The device performing the comparison may include appropriate instructions resident on an appropriate software, hardware, or other computer-readable medium. The instructions for carrying out the comparison and/or other associated tasks are generally programmable instructions, but may be “hardwired” or otherwise made permanent or semi-permanent in particular applications. These functions may be performed by a single device, or by multiple, distributed devices that are networked or otherwise linked in communication with each other.

After process portion 308, the workpiece can be re-oriented using any one (or more) of several different methodologies. One methodology includes placing the workpiece on a support (process portion 309) that is adjacent to the target process chamber. In process portion 310, the support is rotated to correct the rotational orientation of the workpiece. The workpiece is then processed while at the proper rotation and while being carried by the support (process portion 313). The support can include a lift-rotate unit, as shown in FIG. 1, or another suitable device.

Another re-orientation process includes determining the location of the transfer device and the required articulation of its links that will result in the proper orientation of the workpiece as it is handed off to the support (process portion 311). These location parameters can be determined by any suitable computer or controller, including those described above. Once the location parameters are identified, the workpiece is placed on the support (process portion 312) and processed while being carried by the support (process portion 313).

A difference between the two processes described above is that the first process (identified by process portions 309 and 310) uses the support to rotate the workpiece to its correct orientation, while the second process (identified by process portions 311 and 312) uses the relative positions of the transfer device and the articulatable links to provide the correct orientation. Further details of each of these processes are described below with reference to FIGS. 4 and 5, respectively.

FIG. 4 illustrates a representative process in which the workpiece W is re-oriented by the support 112. In this embodiment, the transfer device 120 moves to a predetermined position proximate to a target process chamber 411 and its associated support 112. The sensor 132 identifies the rotational orientation of the workpiece W, e.g., while the transfer device 120 is in transit to the support 112, and the workpiece W is then transferred to the support 112. If the rotational orientation of the workpiece W requires a correction, the correction information is determined by and/or transmitted to the controller 102 (FIG. 1). The controller 102 then directs the second carrier 113 to rotate about axis A by an amount sufficient to correct the rotational orientation of the workpiece W. The second carrier 113 is then inverted, so that the workpiece W rests on a ring contact assembly 116 and the workpiece W is processed at the target process chamber 411. As discussed above, the process conducted at the target process chamber 411 will typically require a specific rotational orientation of the workpiece W. For example, the process may include magnetically orienting conductive particles deposited on the surface of the workpiece W, using a magnetic field provided by one or more magnets 114.

FIG. 5 illustrates the transfer device 120 in the process of adjusting the rotational orientation of the workpiece W as the workpiece is transferred to the second carrier 113. Accordingly, the second carrier 113 need not rotate to achieve the corrected orientation. Instead, the controller 102 (FIG. 1) determines the necessary location of the transfer device 120 along the guidepath 103, and the necessary angular orientations of the arm 126 and the end-effector 128 that will result in the workpiece W arriving at the second carrier 113 in the proper rotational orientation. The controller 102 performs this calculation using the known geometric and kinematic relationships between the second carrier 113, the transfer device 120, the arm 126, and the end-effector 128 to position these components properly. The proper position is obtained by translating the transfer device 120 along the guidepath 103 (as indicated by arrow T), rotating the arm 126 about the arm rotation axis 127 (as indicated by arrow R1), and/or rotating the end effector 128 about the end effector axis 129 (as indicated by arrow R2). Once the workpiece W is properly positioned at the second carrier 113, the second carrier 113 inverts and lowers the workpiece W into the target process chamber 411 for processing.

As noted above, the workpiece W need not be rotated by the second carrier 113 when the method described with reference to FIG. 5 is implemented, at least in some embodiments. In other embodiments, the orientation process performed by the transfer device 120 as shown in FIG. 5 can be supplemented by additionally rotating the workpiece W at the second carrier 113, as discussed above with reference to FIG. 4. This arrangement may be used if, for example, the required correction for the rotational orientation of the workpiece W is beyond the kinematic limits of the transfer device components.

One feature of the illustrated system described above with reference to FIGS. 1-5 is that the workpiece W is rotationally re-oriented without requiring the workpiece to first be delivered to and aligned at a separate pre-aligner station. Instead, a rotational misalignment of the workpiece is identified while the workpiece W is carried by the transfer device 120, and the workpiece W is rotationally re-oriented by the transfer device 120 and/or the support 112 to which the workpiece W is delivered. An advantage of this arrangement is that it is expected to reduce the amount of time required to re-orient the workpiece W, as compared with a process that requires the workpiece W to be re-oriented at a separate pre-aligner station.

Another feature of the illustrated systems and methods described above is that the workpiece W is carried by the same end-effector 128, both when it is being transported between locations at the tool 100, and when its rotational orientation is being assessed. An advantage of this arrangement is that the transfer device 120 need not be outfitted with a separate carrier or support (e.g., a vacuum chuck), just for the purpose of determining the rotational orientation of the workpiece W.

The end-effector 128 illustrated in the Figures is an edge-grip end-effector, but the end-effector 128 can have other configurations in other embodiments. For example, the end-effector 128 can have a vacuum paddle configuration in which it carriers the workpiece W at or toward its center, and holds the workpiece W by drawing a vacuum through one or more vacuum parts. In another embodiment, the end-effector 128 can include multiple pegs, between and/or on which the workpiece W rests.

In a particular arrangement, as noted above, the end-effector 128 is an edge-grip end-effector, and accordingly grips the workpiece W at its edges while the workpiece is transferred to the target process chamber 411 and while the sensor 132 detects the rotational orientation of the workpiece W. An advantage of this arrangement, in addition to protecting the front and back surfaces of the workpiece W, is that the workpiece W can be wet when its orientation is determined and when its orientation is changed. Conversely, a typical vacuum chuck-based pre-aligner requires that the workpiece be dry. By eliminating the requirement for a dry workpiece W, the time necessary to identify and change (if necessary) the rotational orientation of the workpiece W is reduced.

Still another feature of the foregoing embodiments described above with reference to FIGS. 1-5 is that they can be relatively simple to implement. For example, the sensor 132 can be installed on an existing type of transfer device 120, thereby adding the ability to detect the rotational orientation of the workpiece W without affecting many of the existing features of the transfer device 120. Furthermore, if the rotational orientation of the workpiece W is to be updated using the second carrier 113 and the support 112, these components are typically already equipped to rotate the workpiece W, and need only receive information identifying how far to rotate the workpiece W to achieve the proper orientation. If, on the other hand, the transfer device 120 and its articulatable links 124 are used to re-orient the workpiece W, the transfer device 120 typically already includes the articulatable links 124 and accordingly need only receive position information to properly orient the workpieces W.

From the foregoing, it will be appreciated that specific embodiments of the invention have been described herein for purposes of illustration, but that various modifications may be made without deviating from the spirit and scope of the invention. For example, the transfer device may have configurations other than those specifically shown in the Figures and described in the text, and may move along guidepaths other than linear guidepaths (e.g., rotary guidepaths). The illustrated end-effectors may have wheels (as is specifically shown in the Figures) or other gripping features, including vacuum ports carried by a paddle-type end-effector. Certain aspects of the invention described in the context of particular embodiments may be combined or eliminated in other embodiments. For example, the sequence of steps described above with reference to FIG. 4 may in some cases be combined with the sequence of steps described above with reference to FIG. 5. Process steps described above with reference to FIG. 3 (e.g., process portions 302 and/or 303) may be eliminated or performed in a different order in alternate embodiments. Further, while advantages associated with certain embodiments of the invention are described in the context of those embodiments, other embodiments may also exhibit such advantages, and not all embodiments need necessarily exhibit such advantages to fall within the scope of the invention. Accordingly, the invention is not limited except as by the appended claims.

I/We claim:

1. A transfer device for microfeature workpieces, comprising:
a base unit movable along a guide path;
a carrier movable relative to the base unit and having an end-effector positioned to engage a microfeature workpiece and move the microfeature workpiece toward and away from the base; and
a position sensor located to identify a rotational orientation of the microfeature workpiece while the microfeature workpiece is carried by the end-effector.

2. The device of claim 1 wherein the end-effector is rotatable relative to the base about one or more axes eccentric to the microfeature workpiece.

3. The device of claim 1 wherein the carrier includes an arm carried by the base unit and movable relative to the base unit, and wherein the end-effector is carried by the arm and is rotatable relative to the arm.

4. The device of claim 1 wherein the end-effector includes first and second edge grippers positioned at a gripping region that receives a microfeature workpiece, the first edge gripper being movable toward and away from the second edge gripper between a grip position and a release position.

5. The device of claim 1, further comprising:
a wireless communication device operatively coupled to the position sensor and movable with the position sensor along the guide path; and
a controller operatively coupled to the position sensor via a wireless communication link provided by the wireless communication device to receive signals corresponding to the rotational orientation of the microfeature workpiece.

6. The device of claim 1, further comprising a controller operatively coupled to the sensor, the controller being programmed with instructions for:
comparing the rotational orientation of the microfeature workpiece with a target value;
determining a rotational orientation correction value; and
directing a signal corresponding to the correction value.

7. The device of claim 1 wherein the base unit does not carry a device that supports the microfeature workpiece at its center and rotates the microfeature workpiece about its central axis.

8. A system for handling microfeature workpieces, comprising:
a transfer device that is movable along a guide path, the transfer device having a first carrier positioned to releasably carry a microfeature workpiece;
a processing chamber positioned along the guide path;
a support positioned proximate to the processing chamber, the support having a second carrier positioned to carry a microfeature workpiece as it is processed at the processing chamber, the second carrier being rotatable relative to the processing chamber;
a position sensor located to identify a rotational orientation of the microfeature workpiece; and
a controller operatively coupled to the position sensor to receive a signal corresponding to the rotational orientation of the microfeature workpiece, the controller being operatively coupled to the support and programmed with instructions directing the second carrier to rotationally re-orient the microfeature workpiece based at least in part on the signal received from the position sensor.

9. The system of claim 8 wherein the position sensor is carried by the transfer device.

10. The system of claim 8 wherein the controller is programmed with instructions directing the second carrier to:
rotationally re-orient the microfeature workpiece from a first rotational orientation to a second rotational orientation, based at least in part on the signal received from the position sensor; and
maintain the microfeature workpiece in the second rotational orientation while the microfeature workpiece is processed at the process chamber.

11. The system of claim 8 wherein the transfer device includes:
a base unit movable along the guide path; and
an arm carried by the base unit and movable relative to the base unit to rotate a microfeature workpiece about an axis eccentric to the microfeature workpiece.

12. The device of claim 8 wherein the first carrier includes:
an arm carried by the base unit and movable relative to the base unit; and
an end-effector carried by the arm and rotatable relative to the arm.

13. The device of claim 12 wherein the end-effector includes first and second edge grippers positioned at a gripping region that receives a microfeature workpiece, the first edge gripper being movable toward and away from the second edge gripper between a grip position and a release position.

14. The system of claim 8 wherein the first carrier includes multiple end-effectors, with individual end-effectors having first and second edge grippers positioned at an individual gripping region that receives a microfeature workpiece.

15. The system of claim 8 wherein the processing chamber includes a magnet positioned to orient material applied to a microfeature workpiece carried by the second carrier.

16. The system of claim 8, further comprising a wireless communication link between the robot and the controller.

17. The system of claim 8, further comprising a wireless communication device operatively coupled to the position sensor and movable with the position sensor along the guide path, the wireless communication device being coupled to the controller via a wireless communication link to transmit signals corresponding to the rotational orientation of the microfeature workpiece.

18. The system of claim 8 wherein the controller is programmed with instructions for:
comparing the rotational orientation of the microfeature workpiece with a target value;
determining a rotational orientation correction value; and
directing a signal corresponding to the correction value.

19. A method for handling microfeature workpieces, comprising:
identifying a first rotational orientation of a microfeature workpiece while the microfeature workpiece is carried by a transfer device;
transferring the microfeature workpiece from the transfer device to a support positioned proximate to a processing chamber;
rotating the microfeature workpiece from the first rotational orientation to a second rotational orientation by rotating the support, based at least in part on the identified first rotational orientation; and
processing the microfeature workpiece at the processing chamber while the microfeature workpiece is carried by the support in the second rotational orientation.

20. The method of claim 19, further comprising:
comparing the first rotational orientation of the microfeature workpiece with a target value;
determining a rotational orientation correction value; and
rotating the microfeature workpiece by the rotational orientation correction value from the first rotational orientation to the second rotational orientation.

21. The method of claim 19 wherein processing the microfeature workpiece includes applying conductive material to the workpiece and controlling an orientation of the conductive material with a magnet positioned proximate to the processing chamber.

22. The method of claim 19 wherein processing the microfeature workpiece includes depositing material on the microfeature workpiece without rotating the microfeature workpiece.

23. The method of claim 22 wherein processing the microfeature workpiece includes processing the microfeature workpiece while the microfeature workpiece is in a magnetic field and wherein depositing material includes depositing material on the workpiece in an orientation influenced by the magnetic field.

24. The method of claim 19, further comprising rotationally misaligning the microfeature workpiece by repeatedly gripping and releasing wafer prior to identifying the first rotational orientation of the microfeature workpiece.

25. The method of claim 19 wherein identifying the first rotational orientation includes identifying the first rotational orientation while the microfeature workpiece is carried at its edges.

26. A method for handling microfeature workpieces, comprising:
identifying a first rotational orientation of a microfeature workpiece while the microfeature workpiece is carried by an end-effector of a transfer device;
rotating the microfeature workpiece from the first rotational orientation to a second rotational orientation, based at least in part on the identified first rotational orientation; and
processing the microfeature workpiece at the processing chamber while the microfeature workpiece is carried in the second rotational orientation.

27. The method of claim 26 wherein rotating the microfeature workpiece includes transferring the microfeature workpiece from the transfer device to a support positioned proximate to a processing chamber, and then rotating the support, and wherein processing the microfeature workpiece includes processing the microfeature workpiece while the microfeature workpiece is carried by the support in the second rotational orientation.

28. The method of claim 26 wherein the transfer device includes a base and links that are articulatable relative to the base, and wherein rotating the microfeature workpiece includes moving the links relative to the base, and moving the base relative to the process chamber until the microfeature workpiece has the second rotational orientation.

29. The method of claim 26, further comprising:
comparing the first rotational orientation of the microfeature workpiece with a target value;
determining a rotational orientation correction value; and
rotating the microfeature workpiece by the rotational orientation correction value from the first rotational orientation to the second rotational orientation.

30. The method of claim 26 wherein processing the microfeature workpiece includes applying conductive material to the workpiece and controlling an orientation of the conductive material with a magnet positioned proximate to the processing chamber.

31. The method of claim 26 wherein processing the microfeature workpiece includes depositing material on the microfeature workpiece without rotating the microfeature workpiece.

32. The method of claim 31 wherein processing the microfeature workpiece includes processing the microfeature workpiece while the microfeature workpiece is in a magnetic field and wherein depositing material includes depositing material on the workpiece in an orientation influenced by the magnetic field.

33. The method of claim 26, further comprising rotationally misaligning the microfeature workpiece by repeatedly gripping and releasing wafer prior to identifying the first rotational orientation of the microfeature workpiece.

34. The method of claim 26, further comprising gripping the microfeature workpiece at its edges while identifying the first rotational orientation.
